(19) United States
(12) Patent Application Publication
(10) Pub. No.: US 2022/0398513 A1
(43) Pub. Date: Dec. 15, 2022

(54) OPTIMIZATION OF PROCESSING FOR A VISIT RECOMMENDATION SYSTEM

(71) Applicant: SAP SE, Walldorf (DE)

(72) Inventor: Chandan V.A, Bangalore (IN)

(21) Appl. No.: 17/345,587

(22) Filed: Jun. 11, 2021

(51) Int. Cl. G06Q 10/06

(52) U.S. Cl. CPC G06Q 10/0637

(57) ABSTRACT

Computer-readable media, methods, and systems are disclosed for optimizing processing of a visit recommendation to recommend a visit based on an impact of one or more influencing factors determined by executing a script comprising conditions relating to the influencing factors. The script is compiled from a decision table associated with a set of influencing factor configurations by translating the conditions stored within the decision table into conditional statements. A score is calculated based at least in part on the impact, and a visit is recommended based on the score.

### BACKGROUND

In some industries visits are made to service a plurality of entities. A variety of factors may influence the success of these visits and there is currently no optimized way to consider these factors to recommend a visit in real-time. Additionally, problems arise based on the logistics required for processing, storing, and updating large volumes of influencing factors that should be considered when recommending a visit.

Another issue associated with visit recommendation is the high amount of data input and output operations that may be required to consider large volumes of changing influencing factors stored on a traditional database. Such input and output operations are slow, require high processing power, and have additional latency when carried out over a network of servers.

### SUMMARY

Embodiments of the invention solve the above-mentioned problems by providing systems, methods, and computer-readable media for optimizing visit recommendations by considering one or more influencing factors and reducing the number of input and output operations required to recommend a visit. In some embodiments, a decision table is generated from a set of influencing factor configurations and compiled into an executable script. The executable script may include at least one condition which may be used to determine the impact of a specific influencing factor when calculating a score. At least one visit may be recommended based on the calculated score.

A first embodiment of the invention is directed to one or more non-transitory computer-readable media storing computer-executable instructions that, when executed by a processor, perform a method for optimizing processing of a visit recommendation, the method comprising receiving a set of influencing factor configurations, automatically generating a decision table based on the set of influencing factor configurations, compiling the decision table into a locally executable script by translating conditions stored within the decision table into one or more conditional statements based on the set of influencing factor configurations, receiving an input to the executable script via an asynchronous event, wherein the input is indicative of one or more influencing factors, automatically determining an impact of the one or more influencing factors from the executable script by comparing one or more attributes of the input with the one or more conditional statements stored in the executable script, automatically determining, for each of a plurality entities, a score for the respective entity based at least in part on the impact of the one or more influencing factors, determining a highest scoring entity of the plurality of entities, and recommending a visit corresponding to the highest scoring entity.

A second embodiment of the invention is directed to a method for optimizing processing for a visit recommendation, the method comprising receiving a set of influencing factor configurations, automatically generating a decision table based on the set of influencing factor configurations, compiling the decision table into a locally executable script by translating conditions stored within the decision table into one or more conditional statements based on the set of influencing factor configurations, receiving an input to the executable script via an asynchronous event, wherein the input is indicative of one or more influencing factors, automatically determining an impact of the one or more influencing factors from the executable script by comparing one or more attributes of the input with the one or more conditional statements stored in the executable script, automatically determining a first score for a first entity based at least in part on the impact of the one or more influencing factors, and generating a visit recommendation based at least in part on the first score.

A third embodiment of the invention is directed to a system for optimizing processing for a visit recommendation, the system comprising an influencing factor configurator, a decision table translator, a decision table executor, a visit recommender, and a processor programmed to perform a visit recommendation method, the method comprising receiving a set of influencing factor configurations into the influencing factor configurator, automatically generating a decision table based on the set of influencing factor configurations using the decision table translator, compiling the decision table into a locally executable script by translating conditions stored within the decision table into one or more conditional statements based on the set of influencing factor configurations, receiving an input to the executable script via an asynchronous event, wherein the input is indicative of one or more influencing factors, automatically determining an impact of the one or more influencing factors from the executable script by comparing one or more attributes of the input with the one or more conditional statements stored in the executable script using the decision table executor, automatically determining a first score for a first entity based at least in part on the impact of the one or more influencing factors using the visit recommender, and generating a visit recommendation based at least in part on the first score using the visit recommender.

Additional embodiments of the invention are directed to generating a graphical user interface for displaying visit recommendations to a user. Further embodiments of the invention are directed to a method of generating a set of influencing factor configurations. The influencing factor configurations may be provided based on one of user input or an input from a machine learning algorithm.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1 depicts a visit recommendation system for some embodiments of the invention;

FIG. 2 depicts an exemplary data flow of a non-optimal solution for some embodiments of the invention;

FIG. 3A depicts an exemplary data flow of an optimized design time portion of the visit recommendation system for some embodiments of the invention;

FIG. 3B depicts an exemplary data flow of an optimized runtime portion of the visit recommendation system for some embodiments of the invention;

FIG. 4 depicts an exemplary graphical user interface for some embodiments of the invention;

FIG. 5 depicts an exemplary visit recommendation method for some embodiments of the invention; and

FIG. 6 depicts an exemplary hardware platform for some embodiments of the invention.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

In some industries, such as, for example, the consumer goods industry, customer visits are made by delivery drivers or industry representatives to deliver goods, take new orders, take collections, or audit store performance. In such industries, visit recommendations may be provided based on one or more factors influencing the visit. Accordingly, customers may be visited and serviced appropriately in a timely manner to avoid customer dissatisfaction. In some embodiments, specific visit recommendation solutions are employed which overcome the traditional shortcomings related to visit recommendation. These solutions further optimize the visit recommendation process by converting decision tables including influencing factor configurations into executable scripts that are executed quickly to provide visit recommendations in real-time.

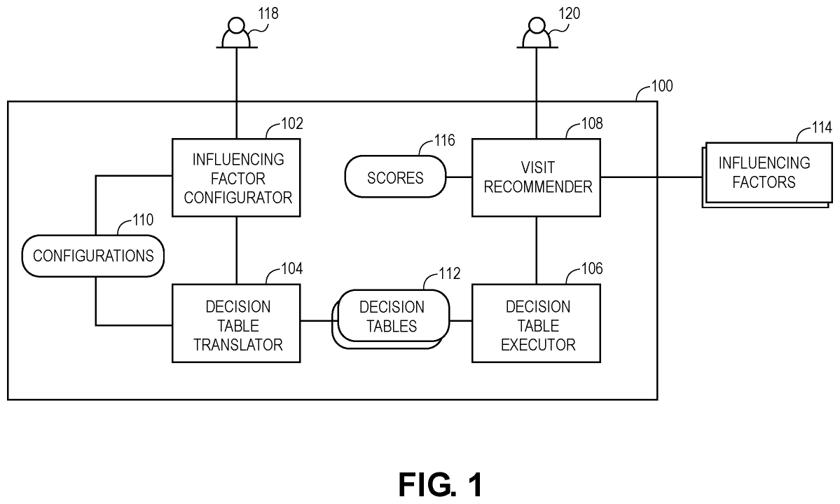

Turning first to FIG. 1, a visit recommendation system 100 is depicted relating to some embodiments of the invention. The visit recommendation system 100 comprises an influencing factor configurator 102, a decision table translator 104, a decision table executor 106, and a visit recommender 108. In some embodiments, the influencing factor configurator 102 provides a plurality of configurations 110 associated with a respective plurality of influencing factors associated with a particular visit or visits in general. For example, in some embodiments, each configuration of the plurality of configurations 110 comprises conditions relating to an influencing factor, conditions relating to one or more classifications or filters for the influencing factor, and an impact of the influencing factor. In some embodiments, the configurations 110 are used to configure a set of parameters associated with a given influencing factor. For example, an administrative user may define configurations 110 that determine the impact of an influencing factor.

In some embodiments, the decision table translator 104 provides a set of decision tables 112, which may be created by transforming the information from the configurations 110 into a table format. Accordingly, the decision tables 112 may each comprise a set of rows and columns of information relating to the influencing factors from the configurations. Table 1 depicted below illustrates an example decision table relating to some embodiments. For example, the decision tables 112 in some embodiments, store information such as, an associated sales organization, a distribution channel, an associated division, a visit type, a type, an effective date, and an impact. As shown in Table 1 below. However, it should be understood that additional types of information related to the influencing factors or the visit may be included in the decision table 112 in addition to or in place of the examples listed herein.

TABLE 1

| Sales | Distribution | | | | | Impact |
|---|---|---|---|---|---|---|
| Organization | Channel | Division | Visit Type | Type | Date | (Output) |
| US North | Direct Sales | Baby Products | Van Selling | Buy One | Buying Date | HIGH |
| | | | | Get One Free | | |
| US South | Direct Sales | Baby Products | Van Selling | Buy One | — | MEDIUM |
| | | | | Get One Free | | |

In some embodiments, the decision tables 112 are received by the decision table executor 106. In some embodiments, the decision tables 112 may be received in an executable format, as will be described below. The decision table executor 106 may be configured to execute the decision tables 112 or an executable script associated with the decision tables 112. In some embodiments, the decision table executor 106 thereby identifies an impact associated with the decision tables 112.

In some embodiments, the visit recommender 108 is configured to recommend a visit to a user based at least in part on scores 116. The scores 116 may be recommendation scores used to rank a plurality of visits based on the impacts associated with the visits. In some such embodiments, a high recommendation score may be associated with a high-impact visit, where the visit will have a significant impact on sales or some other factor depending on the specific application of the particular embodiment. Alternatively, embodiments are contemplated where the score is inversely associated with the determined impact. Here, for example, a low score corresponds to a high impact. Additionally, the visit recommender may receive one or more influencing factors 114. In some such embodiments, the influencing factors 114 may be compared to the decision tables 112 during execution by the decision table executor 106. Accordingly, it may be desirable for the visit recommender 108 to communicate information indicative of the influencing factors 114 to the decision table executor 106. Similarly, the decision table executor 106 may communicate information indicative of the determined impact to the visit recommender 108. In some embodiments, the scores 116 may be determined based at least in part on the impact.

In some embodiments, the visit recommendation system 100 may comprise a design time portion and a runtime portion. In such embodiments, the influencing factor configurator 102 and the decision table translator 104 may be associated with the design time portion. Similarly, the decision table executor 106 and the visit recommender 108 may be associated with the runtime portion. In some embodiments, a first user 118 interacts with the design time portion of the visit recommendation system 100. For example, the first user 118 may be a business administrator that defines and configures a set of influencing factors using the influencing factor configurator 102. In some embodiments, the configurations 110 may be based at least in part on the influencing factors received from the first user 118. In some embodiments, a second user 120 may interact with the runtime portion of the visit recommendation system 100. Accordingly, the second user 120 may be an end user utilizing the visit recommendation system 100 to request a visit recommendation to plan a visit. In such an example, the end user may be a visit planner planning a plurality of visits. Here, the end user may also be a delivery driver planning their own visits or another user planning visits on behalf of the delivery driver. However, it should be understood that this is just one example use case for such embodiments.

It should be understood that a variety of different influencing factors 114 are contemplated, such as, for example, visit coverage, sales promotions, overdue tasks, perfect scores, customer feedback, and other visit influencing factors. In some embodiments, the influencing factors 114 may be configured and defined by users such that additional figures may be added. Further, in some embodiments, the influencing factors 114 may include any factors influencing the success or failure of a particular visit. Here, in some embodiments, success may be attributed to sales associated with a visit or customer satisfaction. In these embodiments, success of a visit may be determined according to the specific requirements of a specific user or a specific organization, as configured by an administrative user through the influencing factor configurator 102. Accordingly, the user-configurable configurations 110 allow the visit recommendation system 100 to be catered to the specific needs of a particular user or group of users. For example, if a particular influencing factor is deemed to be unimportant by an administrative user, the influencing factor the configurations 110 may be established such that the influencing factor is given a low impact or no impact at all. Similarly, an influencing factor deemed to be vital to success may be given a high-impact as instructed by the configurations 110.

In some embodiments, the configurations 110 may be periodically updated, for example, by an administrative user. Further, in some embodiments, the configurations 110 may be updated using a machine learning algorithm, such as an artificial neural network. Here, the machine learning algorithm may be trained using historical visit recommendation data from previous visit recommendations. In some such embodiments, the machine learning algorithm may be continuously updated after each recommendation such that the accuracy of the visit recommendation system 100 improves over time. In such embodiments, the first user 118 may be replaced with the machine learning algorithm which interfaces with the influencing factor configurator 102 to provide and update configurations 110. Further, in some embodiments, the machine learning algorithm may be a component of the influencing factor configurator 102. Further still, embodiments are contemplated where configurations 110 are provided and updated by either of the first user 118 or the machine learning algorithm.

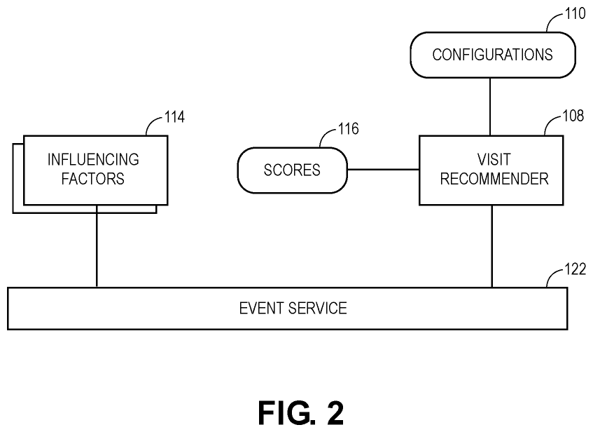

Turning now to FIG. 2, an exemplary data flow of a non-optimal solution for the visit recommendation system 100 relating to some embodiments. In such embodiments, a read operation is executed for every change published for the influencing factors 114. In some such embodiments, the influencing factors 114 may be published to an event service 122 associated with the visit recommendation system 100. Accordingly, the changes are received by the visit recommender 108 from the event service 122 after being published. The visit recommender, after receiving the changes to the influencing factors, computes scores 116. Such embodiments provide a non-optimal solution due to the number of input and output operations associated with retrieving the changes in the influencing factors from a database, especially considering the potential high volume of influencing factors. Accordingly, in some embodiments, it may be desirable to reduce the number of input and output operations and quickly match a given influencing factor with an appropriate configuration. For example, the decision tables 112 may be compiled into executable scripts which reduces the number of input and output operations necessary to calculate the scores 116.

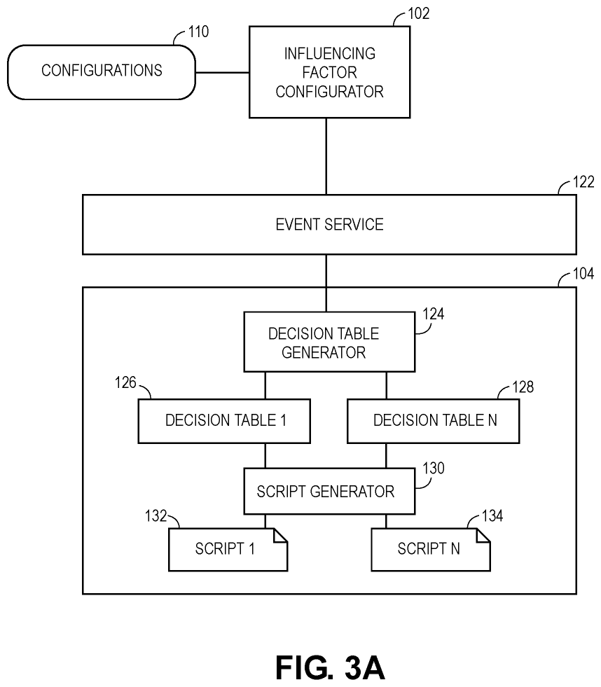

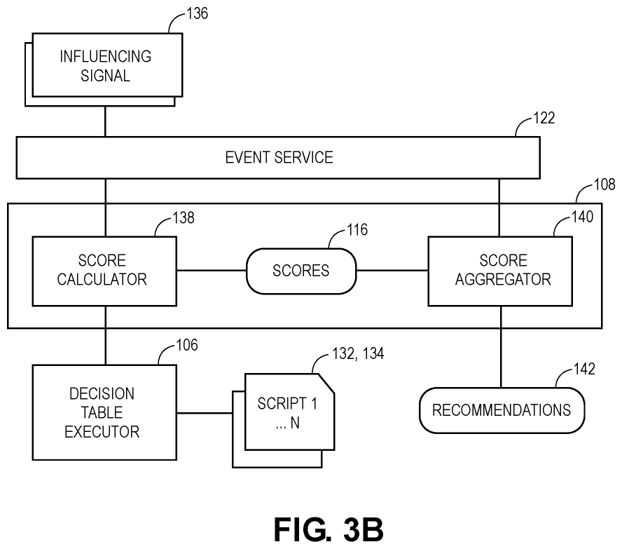

Turning now to FIG. 3A, an exemplary data flow of an optimized solution for the design time portion of the visit recommendation system 100 is depicted relating to some embodiments. In such embodiments, configurations 110 are received by the influencing factor configurator 102, which reads the changes and publishes the changes to the event service 122. In such embodiments, the decision table translator 104 comprises a decision table generator 124 generating decision tables 1-N, 126, 128, and a script generator 130 generating scripts 1-N, 132, 134. Here, the decision table generator 124 may generate the first decision table 126 based at least in part on a first change or update to a configuration. Similarly, the Nth decision table 128 may be generated based at least in part on an Nth change to a configuration. It should be understood that one or more decision tables may be generated in some embodiments. In some embodiments, storing the configurations in decision tables may be desirable such that additional attributes and conditions may be added and updated without adjusting code or implementation of the configurations.

The script generator 130 may be configured to generate at least one executable script based on the decision tables 112 generated by the decision table generator 124. In some embodiments, the script generator 130 compiles a decision table into a locally executable script by translating conditions of the decision table into one or more conditional statements. The conditional statements are then stored within the executable script. Accordingly, the script generator 130 may generate a first executable script 132 based on the first decision table 126 and an Nth executable script 134 based on the Nth decision table 128. It should be understood that any number of executable scripts may be generated based on corresponding decision tables from the decision table generator 124. In some embodiments, a single executable script is generated for a given decision table for a one-to-one ratio. In such embodiments, the script generator 130 compiles the information stored in the decision table into an executable script which may be stored in memory and executed by the decision table executor 106. For example, the executable scripts may be saved as Groovy scripts, Java scripts, or other ECMAScript-type scripts. However, it should be understood that other types of script formats are also contemplated for some embodiments. Alternatively, in some embodiments, a plurality of decision tables may be compiled into a single executable script or a plurality of executable scripts may be generated based on a single decision table.

In some embodiments, each of the executable scripts comprises simple IF, ELSE IF, and THEN conditional statements which are used to determine an impact when executed by the decision table executor 106, as will be described in further detail below. In such embodiments, it may be desirable to compile the decision tables 112 into executable scripts to reduce the number of input and output operations necessary to determine the impact and calculate the scores 116. Accordingly, impacts are determined and scores are calculated by executing scripts which may be stored locally rather than requesting and looking up information from a remote database. Additionally, the optimized solution shown in FIG. 3A may desirably reduce the number of physical components needed to recommend visits because a plurality of databases are not required to store tables of accessible information. Instead, the decision tables are converted into executable scripts which do not need to be stored in an external database.

An exemplary scenario employing the components shown in FIG. 3A will now be described. In such an example, an instance of the visit recommendation system 100 may be hosted on a user device of an administrative user, such as first user 118. The visit recommendation system 100 may be hosted on the user device as a client application running on the user device or from within a web browser on the user device. The administrative user is an administrator of a delivery company who wishes to configure the influencing factors used to recommend visits for the delivery company to visit various customers. Accordingly, the administrative user may operate the user device to interact with the visit recommendation system 100 to generate a set of influencing factor configurations 110, for example, using the influencing factor configurator 102.

In this example, the administrative user notices that sales are dropping for entity accounts that have not been visited for longer than a month. Accordingly, the administrative user provides an update to a last visit time influencing factor such that the entities which have not been visited for an extended duration of time will receive a high impact. It should be understood that the specific length of time may be further configurable by the user. For example, entities which have not been visited for more than two weeks may be associated with a high impact. Alternatively, the high impact may be reserved for entities which have not been visited for over a month. However, it should be understood that any length of time may be used. Further, in some embodiments, the impact may be determined relative to the length of time, such that entities not visited for over a month receive a high impact, entities not visited for over a week receive a low impact, and entities visited within the last week receive no impact.

The inputs from the administrative user are used to generate the influencing factor configurations 110 which may be provided to the event service 122. Accordingly, a configuration for the last visit time influencing factor is updated and the decision table generator 124, which is subscribed to the event service 122, receives the updated configuration. The decision table generator 124, then generates an updated decision table based on the new configuration and the script generator 130 compiles the updated decision table into an executable script. After the executable script is compiled the executable script may be distributed to all user devices of the delivery company such that the visit recommendation system 100 on each user device is up to date and uses the same executable script to determine impacts and calculate scores.

Turning now to FIG. 3B, an exemplary data flow of the optimized solution for the runtime portion of the visit recommendation system 100 is depicted relating to some embodiments. In such embodiments, an influencing signal 136 is published to the event service 122. The influencing signal 136 may be associated with a change to an influencing factor or addition of a new influencing factor. In some embodiments, the visit recommender 108 comprises a score calculator 138 and a score aggregator 140. The score calculator 138 subscribes to changes in influencing factors published to the event service from the influencing signal 136 and calculates scores 116. In some embodiments, the score calculator 138 receives information of the impact associated with a given influencing factor from the decision table executor 106. Here, the decision table executor 106 may execute one of executable scripts 1-N, 132, 134, as shown. Said scripts may be received from the script generator 130 of the decision table translator 104. In some embodiments, the score calculator 138 may be subscribed to changes in configurations 110 such that when the configurations 110 are changed, updated, or added, the score calculator 138 receives updated executable scripts incorporating the configuration changes.

In some embodiments, the decision table executor 106 receives an input for the executable script. For example, the input may be received as a JavaScript Object Notation (JSON) object via an asynchronous event. In some such embodiments, the JSON object is received from an asynchronous event published to the event service 122. For example, the input may comprise a JSON object associated with the influencing signal 136. In some embodiments, the input may be associated with the influencing factor and comprises a set of attributes corresponding to the influencing factor. Accordingly, the decision table executor 106 executes the executable script with the input and compares the attributes of the input against the conditions maintained in the executable script to determine an output. In some embodiments, the output of the executable script is used to determine the impact of the given influencing factor. If a condition matches, an impact is returned. Alternatively, if no condition matches, an empty response is returned indicative of no associated impact for the influencing factor. In some embodiments, a zero impact may be returned in place of the empty response if none of the conditions match the attributes of the input.

In some embodiments, the impact returned by the decision table executor 106 after executing the script may be considered by the score calculator 138 in caclulating a score. The score is then stored with the scores 116 which are accessible to the score aggregator 140. The score aggregator 140 reads the relevant scores of the plurality of scores 116 calculated by the score calculator 138 and determines recommendations 142 based on the scores. For example, the relevant scores may be scores associated with a specific sales area. In some embodiments, the recommendations 142 correspond to visits which have the highest score. In some embodiments, the score calculator 138 and the score aggregator 140 precompute the scores for all relevant entities in the visit recommendation system 100 and store said scores. Accordingly, the response time of the visit recommendation system 100 is improved by precomputing the relevant scores such that the scores may be computed in the background without user input. Here, for example, the scored may be computed by the visit recommendation system running in the background on the user's device.

In some embodiments, the decision table executor 106 may execute the executable script in under one second, such that a visit is recommended in real-time. Such an execution speed may be attributable to the reduction in input/output operations from a database associated with compiling the decision tables into executable scripts. In some embodiments, a visit recommendation may be generated without any input/output operations from a database, such that the speed and processing of the visit recommendation is optimized. Additionally, storage costs associated with database storage are reduced.

Continuing the exemplary scenario discussed above, with respect to the delivery company, the components of FIG. 3B may be employed. Accordingly, the executable script produced from the update to the last visit time influencing factor configuration is received by the decision table executor 106. In this example, an end user operates a user device to interact with the visit recommendation system 100. In this example, the end user is a delivery manager utilizing the visit recommendation system 100 to plan visits for a plurality of delivery drivers. However, it should be understood that the visit recommendation system 100 may be used by the drivers directly to plan visits.

The influencing signal 136, in this case, may include influencing factors for a specific sales account associated with a customer of the delivery company. Here, the influencing signal 136 includes a last visit time influencing factor indicating that the sales account has not been visited for two months. The influencing signal is provided by the event service 122 to the score calculator 138 and the decision table executor 106. The decision table executor 106 executes the executable script with the last visit time influencing factor as an input, received as a JSON object. Based on the updated configurations and the influencing signal, the conditions within the executable script determine a high impact because the entity has not been visited for over one month.

The high impact is provided to the score calculator 138 which calculates a score for the sales account based on the high impact associated with the last visit time influencing factor along with additional impacts associated with additional influencing factors of the sales account. For the sake of the example, a relatively high score is calculated for the sales account and the score aggregator 140 provides a recommendation to visit the sales account based on the high score. It should be understood that this is just one example use case of the visit recommendation system 100 and that the visit recommendation system 100 may be used in a variety of different ways within a variety of different industries not discussed herein.

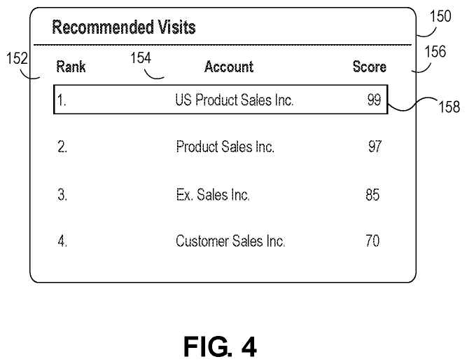

Turning now to FIG. 4, an exemplary graphical user interface 150 for recommending visits is depicted relating to some embodiments. Graphical user interface 150 may be displayed to a user on a user device in association with one of a web browser or a client application running on the user device. In some embodiments, the graphical user interface 150 may be used to display the recommendations 142 determined by the score aggregator 140 of the visit recommender 108. In some such embodiments, the graphical user interface 150 may display at least one of a list of rankings 152, accounts 154, and scores 156 corresponding to a respective set of recommended visits, as shown. The listed accounts 154 correspond to a plurality of respective entities. The scores 156 may be the same as scores 116 calculated by the score calculator 138. In some embodiments, only the most significant (highest scoring) visits are recommended and displayed on the graphical user interface 150. Alternatively, embodiments are contemplated where all visits are displayed or where the user is allowed to scroll between the visits. Further still, embodiments are contemplated where only the highest scoring visit is recommended and displayed on the graphical user interface 150.

In one example embodiment, the highest scoring visit 158 is highlighted or outlined, as shown. Here, the highest scoring visit 158 has a ranking of one and a relatively high score of ninety-nine with the next highest score being ninety-seven. In some such embodiments, the scores 156 may range from one to one-hundred with one-hundred corresponding to the highest impact visit. Alternatively, the scores may be selected from one to ten or some other set of numbers. Further still, the scores may be separated into categories by letter grades A through F with A+ corresponding to the highest impact and F− corresponding to the lowest impact.

In some embodiments, it may be desirable to include additional information on the graphical user interface 150. For example, the graphical user interface 150 may comprise information indicative of the influencing factors used in the determination of the score 156. Accordingly, the user may view the influencing factors and be informed why the score was received. For example, if an entity receives a high score the user may be informed of the associated influencing factors such as if the entity has not been visited for an extended period of time. Further, in some embodiments, the graphical user interface 150 may display visit recommendations for a plurality of entities in a recommended visit order. The recommended visit order may be determined based at least in part on the scores for the visits and, in some embodiments, further based on the location of the visits. Accordingly, in some embodiments, the visit recommendation system 100 may interact with or include a location service for determining the locations of the visits and the location of the user. For example, in one embodiment, the visit recommendation system 100 may be running on a user's device, such as a mobile phone, where the visit recommendation system 100 considers GPS location information from a GPS receiver disposed in the user device to determine the visit recommendation order based in part on the user's location.

Visit recommendation system 100 may be configured to provide visit recommendations to a user in real time. Accordingly, the graphical user interface 150 may display visit recommendations to the user periodically or based on a user input or request. For example, a user may interact with the graphical user interface 150 to request a visit recommendation, which triggers the visit recommendation to be displayed on the graphical user interface 150. It should be understood that the visit recommendations may be determined automatically in the background by the visit recommendation system such that the recommendations are already available when requested by the user. Additionally, in some embodiments, the visit recommendations may be displayed and updated continuously on the graphical user interface 150 based on information received from the visit recommendation system 100.

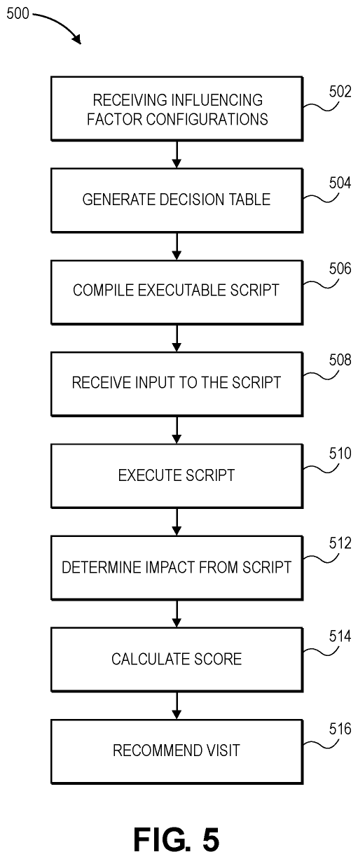

Turning now to FIG. 5, an exemplary visit recommendation method 500 is depicted relating to some embodiments. In some embodiments, at least a portion of the visit recommendation method 500 may be performed with respect to a plurality of entities. Each of the plurality of entities may be associated with a specific customer account. For example, in some embodiments, the visit recommendation system 100 is used to determine which client account should be visited out of a plurality of client sales accounts for a delivery service. However, it should be understood that embodiments may provide visit recommendations for a variety of different goods and services. It should be understood further that, in some embodiments, at least a portion of the visit recommendation method 500 are performed by the visit recommendation system 100.

At step 502 a set of influencing factor configurations is received by the influencing factor configurator 102. At step 504 a decision table is generated based on the set of influencing factor configurations. In some embodiments, the decision table may be generated automatically upon receiving the influencing factor configurations or upon receiving an update to the influencing factor configurations. At step 506 the information from the generated decision table is compiled into an executable script. In some embodiments, the executable script comprises a set of conditions. For example, the set of conditions may include conditional statements such as IF, ELSE IF, and THEN statements, as discussed above.

At step 508 at least one input indicative of one or more influencing factors is received. In some embodiments, the input is received by the visit recommender 108. The input may comprise one or more attributes associated with the one or more influencing factors. In some embodiments, the input comprises an influencing factor associated with a specific entity for which a score is being determined. For example, an entity with a corresponding set of influencing factors may be considered. At step 510 the executable script is executed. In some embodiments, the executable script may be executed with the input received using the decision table executor 106. As discussed above, the executable script may comprise a set of conditional statements to which the input is compared. At step 512 an impact is determined from the executable script based on the input and the contents of the executable script. For example, the script may compare attributes of the input with the conditions stored in the script to determine an impact associated with the input.

At step 514 a score is calculated for the respective entity based on the impact determined by executing the script using the score calculator 138. In some embodiments, the score for the entity may be calculated based on a plurality of impacts corresponding to a respective plurality of influencing factors of the entity. In some embodiments, the score may be calculated by averaging the determined impact for a given entity. Here, each impact may be associated with a weight which determines the effect of the particular impact. Alternatively, in some embodiments, all impacts have the same effect. In some embodiments, alternative techniques may be used to calculate the score. Further, embodiments are contemplated where a score may be calculated based on a single impact.

At step 516 at least one visit associated with a respective entity is recommended based on the calculated score for the entity. In some embodiments, the score is recommended using the score aggregator 140 to provide the recommendations 142. In some embodiments, a plurality of visits may be recommended based on a respective plurality of calculated scores. For example, in some embodiments, the four highest scoring visits may be recommended. In some embodiments, it may be desirable to calculate scores for a plurality of entities before recommending a visit. Accordingly, steps 508-514 may be repeated for each of the plurality of entities to determine a score for the entities based on a respective plurality of influencing factors for the entities. Here, a first score may be calculated with respect to a first entity and a subsequent score may be calculated with respect to a subsequent entity. Further, in some embodiments, a visit is only recommended for the highest scoring entity of a plurality of entities. In some embodiments, the visit may be recommended to a user using a graphical user interface such as the graphical user interface 150 of FIG. 4. However, it should be understood that the visit may be recommended in a variety of ways. For example, in some embodiments, the visit is recommended via a text notification to the user.

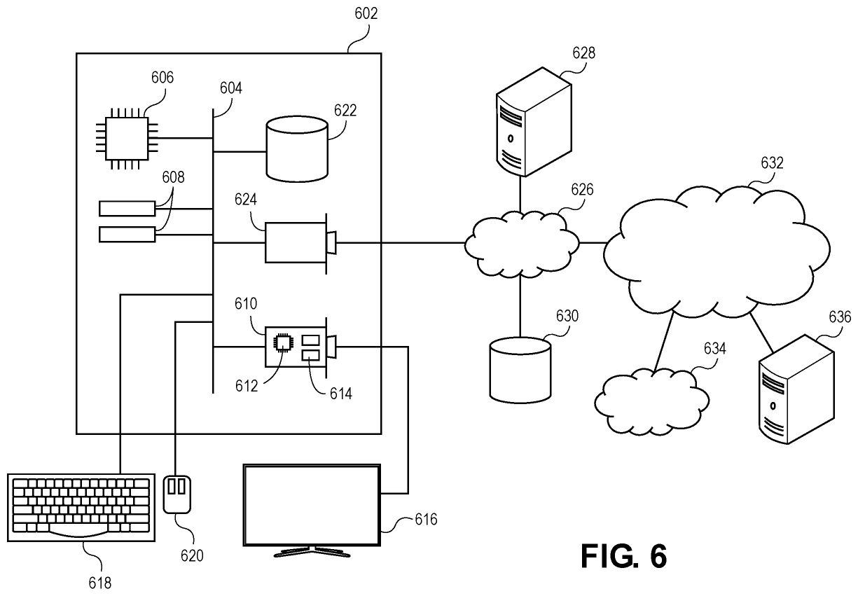

Turning now to FIG. 6, an exemplary hardware platform for certain embodiments of the invention is depicted. Computer 602 can be a desktop computer, a laptop computer, a server computer, a mobile device such as a smartphone or tablet, or any other form factor of general- or special-purpose computing device. Depicted with computer 602 are several components, for illustrative purposes. In some embodiments, certain components may be arranged differently or absent. Additional components may also be present. Included in computer 602 is system bus 604, whereby other components of computer 602 can communicate with each other. In certain embodiments, there may be multiple busses or components may communicate with each other directly. Connected to system bus 604 is central processing unit (CPU) 606. Also attached to system bus 604 are one or more random-access memory (RAM) modules 608. Also attached to system bus 604 is graphics card 610. In some embodiments, graphics card 610 may not be a physically separate card, but rather may be integrated into the motherboard or the CPU 606. In some embodiments, graphics card 610 has a separate graphics-processing unit (GPU) 612, which can be used for graphics processing or for general purpose computing (GPGPU). Also on graphics card 610 is GPU memory 614. Connected (directly or indirectly) to graphics card 610 is display 616 for user interaction. In some embodiments no display is present, while in others it is integrated into computer 602. Similarly, peripherals such as keyboard 618 and mouse 620 are connected to system bus 604. Like display 616, these peripherals may be integrated into computer 602 or absent. Also connected to system bus 604 is local storage 622, which may be any form of computer-readable media, and may be internally installed in computer 602 or externally and removably attached.

Computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-useable instructions, data structures, program modules, and other data representations.

Finally, network interface card (NIC) 624 is also attached to system bus 604 and allows computer 602 to communicate over a network such as network 626. NIC 624 can be any form of network interface known in the art, such as Ethernet, ATM, fiber, Bluetooth, or Wi-Fi (i.e., the IEEE 802.11 family of standards). NIC 624 connects computer 602 to local network 626, which may also include one or more other computers, such as computer 628, and network storage, such as data store 630. Generally, a data store such as data store 630 may be any repository from which information can be stored and retrieved as needed. Examples of data stores include relational or object oriented databases, spreadsheets, file systems, flat files, directory services such as LDAP and Active Directory, or email storage systems. A data store may be accessible via a complex API (such as, for example, Structured Query Language), a simple API providing only read, write and seek operations, or any level of complexity in between. Some data stores may additionally provide management functions for data sets stored therein such as backup or versioning. Data stores can be local to a single computer such as computer 628, accessible on a local network such as local network 626, or remotely accessible over Internet 632. Local network 626 is in turn connected to Internet 632, which connects many networks such as local network 626, remote network 634 or directly attached computers such as computer 636. In some embodiments, computer 602 can itself be directly connected to Internet 632.

It should be understood that, in some embodiments, the computer 602 may be used to host an instance of the visit recommendation system 100. Here, the display 616 may be used to display the graphical user interface 150 described with respect to FIG. 4. Further, in some embodiments, the visit recommendation method 500 of FIG. 5 may be performed using a processor, such as central processing unit (CPU) 606. Additionally, in some embodiments, steps of method 500 may be distributed and carried out on a plurality of processors where one step is carried out on a first processor and another step is carried out on a second processor. Further still, in some embodiments, the visit recommendation method 500 may be executed by a processor on a user device of either of the first user 118 or the second user 120. In some embodiments, a first portion of steps may be performed by the user device of the first user 118 and a second portion of the method may be performed by the user device of the second user 120. Accordingly, embodiments are contemplated where the components of the visit recommendation system 100 are hosted by the user devices and distributed across a plurality of user devices. Additionally, in some embodiments, an independent instance of the visit recommendation system 100 may be hosted on each user device.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. One or more non-transitory computer-readable media storing computer-executable instructions that, when executed by a processor, perform a method for optimizing processing of a visit recommendation, the method comprising:
receiving a set of influencing factor configurations;
automatically generating a decision table based on the set of influencing factor configurations;
compiling the decision table into a locally executable script by translating conditions stored within the decision table into one or more conditional statements based on the set of influencing factor configurations;
receiving an input to the executable script via an asynchronous event,
wherein the input is indicative of one or more influencing factors;
automatically determining an impact of the one or more influencing factors from the executable script by comparing one or more attributes of the input with the one or more conditional statements stored in the executable script;
automatically determining, for each of a plurality entities, a score for the respective entity based at least in part on the impact of the one or more influencing factors;
determining a highest scoring entity of the plurality of entities; and
recommending a visit corresponding to the highest scoring entity.

2. The computer-readable media of claim 1, wherein the visit corresponding to the highest scoring entity is recommended to a user on a graphical user interface associated with one of a web browser or a client application.

3. The computer-readable media of claim 2, wherein additional information is presented on the graphical user interface including a set of influencing factors associated with the score.

4. The computer-readable media of claim 1, wherein if it is determined that the one or more attributes of the input do not match the conditions stored within the executable script, an empty response is returned indicative of no impact.

5. The computer-readable media of claim 1, further comprising:
updating the executable script based on a received change to an influencing factor configuration of the set of influencing factor configurations; and
updating the score for a respective entity of the plurality of entities based on a change in the one or more influencing factors.

6. The computer-readable media of claim 1, wherein the executable script is executed in under one second.

7. The computer-readable media of claim 6, further comprising: distributing the executable script to a plurality of servers.

8. A method for optimizing processing for a visit recommendation, the method comprising:
receiving a set of influencing factor configurations;
automatically generating a decision table based on the set of influencing factor configurations;
compiling the decision table into a locally executable script by translating conditions stored within the decision table into one or more conditional statements based on the set of influencing factor configurations;
receiving an input to the executable script via an asynchronous event,
wherein the input is indicative of one or more influencing factors;
automatically determining an impact of the one or more influencing factors from the executable script by comparing one or more attributes of the input with the one or more conditional statements stored in the executable script;
automatically determining a first score for a first entity based at least in part on the impact of the one or more influencing factors; and
generating a visit recommendation based at least in part on the first score.

9. The method of claim 8, further comprising:
automatically determining a second score for a second entity; and
comparing the second score to the first score,
wherein, if the second score is higher than the first score, the visit recommendation recommends a visit to the second entity, and
wherein, if the second score is lower than the first score, the visit recommendation recommends a visit to the first entity.

10. The method of claim 8, further comprising:
automatically determining one or more subsequent scores for one or more subsequent entities, respectively; and
comparing the one or more subsequent scores and the first score.

11. The method of claim 10,
wherein the visit recommendation is configured to be presented to a user on a graphical user interface, and
wherein the graphical user interface displays information indicative of the first score and the one or more subsequent scores.

12. The method of claim 11, wherein the graphical user interface further displays information indicative of the one or more influencing factors.

13. The method of claim 8, wherein the input comprises a JavaScript Object Notation (JSON) object including the one or more influencing factors, and wherein the executable script comprises one or more conditional statements.

14. The method of claim 8, wherein the set of influencing factor configurations are received from an administrative user operating a user device.

15. The method of claim 8, wherein the one or more influencing factors includes historical visit information related to the first entity.

16. A system for optimizing processing for a visit recommendation, the system comprising:
an influencing factor configurator;
a decision table translator;
a decision table executor;
a visit recommender; and
a processor programmed to perform a visit recommendation method, the method comprising:
receiving a set of influencing factor configurations into the influencing factor configurator;
automatically generating a decision table based on the set of influencing factor configurations using the decision table translator;
compiling the decision table into a locally executable script by translating conditions stored within the decision table into one or more conditional statements based on the set of influencing factor configurations;
receiving an input to the executable script via an asynchronous event,
wherein the input is indicative of one or more influencing factors;
automatically determining an impact of the one or more influencing factors from the executable script by comparing one or more attributes of the input with the one or more conditional statements stored in the executable script using the decision table executor;
automatically determining a first score for a first entity based at least in part on the impact of the one or more influencing factors using the visit recommender; and
generating a visit recommendation based at least in part on the first score using the visit recommender.

17. The system of claim 16, further comprising a plurality of servers, wherein the executable script is distributed to the plurality of servers after being compiled or updated.

18. The system of claim 16, wherein the processor is further programmed to perform:
determining a second score for a second entity;
generating a second visit recommendation based at least in part on the second score.

19. The system of claim 18, further comprising a graphical user interface for displaying at least one of the first score and the second score.

20. The system of claim 19, wherein the graphical user interface further displays information indicative of the one or more influencing factors.
